(19) United States
(12) Patent Application Publication
(10) Pub. No.: US 2018/0192112 A1
(43) Pub. Date: Jul. 5, 2018

(54) System and method for delivering video content

(71) Applicant: iVent Mobile B.V., Laren (NL)

(72) Inventors: Mattheus T. Bloemheuvel, Laren (NL); Kees Jan Mink, Laren (NL); Carel Begeer, Laren (NL)

(73) Assignee: iVent Mobile B.V., Laren (NL)

(21) Appl. No.: 15/862,648

(22) Filed: Jan. 5, 2018

(30) Foreign Application Priority Data
Jan. 5, 2017 (NL) 2018130

(51) Int. Cl. H04N 21/414; H04N 21/2343

(52) U.S. Cl. CPC H04N 21/41422; H04N 21/41407; H04N 21/2343

(57) ABSTRACT

A method of delivering video content to mobile remote locations includes a) providing video content through a content source facility; b) transcoding the video content to a predetermined bitrate at the content source facility; c) distributing the transcoded video content from the content source facility to one or more base stations; d) transmitting the transcoded video content from the one or more base stations to one or more remote receivers through one-on-one wireless communication; and e) delivering the transcoded video content by the one or more remote receivers to one or more playout devices being in communication with one of the one or more remote receivers.

### FIELD OF THE INVENTION

The present invention relates to a method of delivering video content, in particular a system for delivering video content to mobile remote receivers such as personal devices on board an aircraft. In a further aspect the present invention relates to a system for delivering video content to mobile remote receivers.

### BACKGROUND ART

International patent application WO 2004/008277 A2 discloses an in-flight passenger entertainment system for an aircraft or other vehicle, utilizing a distributed network server architecture to host and support a variety of audio/visual content providing applications. A communications management unit is provided allowing connectivity between the distributed network architecture and various satellites constellations, wireless, or ground broadband signal sources. A distributed server architecture is implemented in a wireless LAN configuration, allowing passengers to access World Wide Web functionality, e-mail functionality as well as multimedia content, broadcast television, cellular telephone communication, and the like. Individual nodes of the distributed network architecture host individual ones of the various communication applications such that a central server and centralized distribution network is no longer necessary.

### SUMMARY

The present invention seeks to provide a method of delivering video content to mobile remote receivers.

According to the present invention, a method as described in the preamble is provided comprising providing video content through a content source facility and transcoding the video content to a predetermined bitrate at the content source facility. The method then involves distributing the transcoded video content from the content source facility to one or more base stations and transmitting the transcoded video content from the one or more base stations to one or more remote receivers through one-on-one wireless communication, wherein the method continues with delivering the transcoded video content by the one or more remote receivers to one or more playout devices being in communication with one of the one or more remote receivers. The present invention method allows efficient delivery of high definition video content through relatively low bandwidth connections exhibiting high roundtrip times and burst errors caused by e.g. climate and weather conditions.

According to the presenting invention, the method performs transcoding of video content to a predetermined bitrate as early as possible within a chain of events for delivering video content to mobile remote receivers. Such “early” transcoding to a predetermined bitrate may involve transcoding to a sufficiently low bitrate suitable for efficient use of low bandwidth network connections, also possibly exhibiting high roundtrip times and burst errors. Because transcoding of video content is performed as early as possible, subsequent method steps for delivering the video content may be performed on limited bandwidth connections within a network.

The method of the present invention further allows for one-on-one wireless communication between one or more base stations and one or more mobile remote receivers, so that method steps associated with relaying video content are circumvented. For example, in existing prior art methods for delivering content, one or more relaying steps are performed by an intermediate satellite or antenna station interposed between a base station and a mobile remote receiver. Such relaying steps not only add further overhead but may also impose further bandwidth limitation on the network and increase roundtrip times as well as burst errors. Instead, transmitting transcoded video content from a base station to a remote receiver through one-on-one wireless communication will therefore eliminate such relaying steps.

In another aspect the present invention relates to a system of the type described in the preamble comprising a content source facility arranged for providing transcoded video content of a predetermined bitrate, wherein the content source facility is connected to one or more base stations and arranged to distribute the transcoded video content thereto. One or more remote receivers are in one-on-one wireless communication with one or more of the one or more base stations and are arranged for receiving the transcoded video content therefrom. The one or more remote receivers are arranged for delivering the transcoded video content to one or more playout devices, wherein the one or more playout devices are in communication with one of the one or more remote receivers.

### SHORT DESCRIPTION OF DRAWINGS

The present invention will be discussed in more detail below, with reference to the attached drawings, in which

FIG. 1 shows a schematic view of a system for delivering video content to mobile remote receivers according to an embodiment of the present invention; and

FIG. 2 shows a schematic view of a three layered distribution model for delivery of video content to mobile remote receivers according to an embodiment of the present invention.

### DESCRIPTION OF EMBODIMENTS

Because of the increasing role of network, cable network and internet based communications, there is an increasing demand for delivering various types of content over such networks and the internet to a consumer. However, not all network and internet connections provide sufficiently high bandwidth or throughput for delivering e.g. high quality video content. This is often the case for wireless network communications over satellite and/or radio connections that are characterized by relatively high roundtrip times (RTT), low and expensive bandwidth channels and burst error behaviour. For example, in many prior art systems for delivering video content to mobile remote receivers data first has to travel to a ground station, then up to a satellite and down again to a remote receiver and vice versa. Consequently, methods and systems for facilitating such data transmissions add considerable overhead, latency and reduced data throughput, and moreover burst errors may cause additional packet loss and increase delays due to retransmissions. Therefore, methods and systems relying on responses, such as TCP, suffer from such delays.

The above issues often lead to e.g. poor responsiveness of the system as well as buffer overflows and poor utilization of bandwidth. Even though a number of methods and systems attempt to address this by e.g. TCP spoofing, such methods and systems have varying implementation demands causing such system to only support such specific methods.

In view of the above there is a need for an improved method for reliable, flexible and efficient delivery of video content to mobile remote receivers over data networks and internet connections having limited bandwidth and are prone to exhibiting high roundtrip times and/or burst errors. Furthermore, there is also a need for a system for delivering video content to mobile remote receivers arranged for executing the improved method.

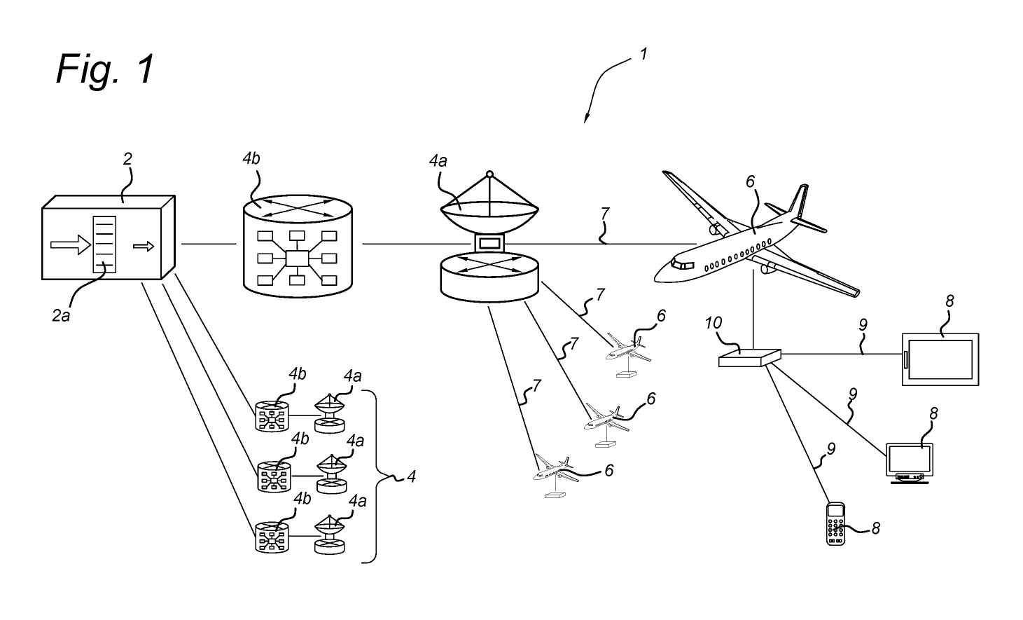

FIG. 1 shows a schematic view of a system 1 for delivering video content to mobile remote receivers according to an embodiment of the present invention. In the depicted embodiment the system 1 comprises a content source facility 2 arranged for providing transcoded video content of a predetermined bitrate. In an embodiment the content source facility 2 comprises an encoder unit 2a arranged for transcoding video content to the predetermined bitrate. The predetermined bitrate for transcoding the video content may be chosen to make efficient use of available bandwidth and to anticipate limited bandwidth capacity, high return times and/or burst errors.

The content source facility 2 is connected to one or more base stations 4 and arranged to distribute the transcoded video content to the one or more base stations 4. In the depicted embodiment of FIG. 1, a base station 4 may be a satellite or a radio base station 4a. In a further embodiment, the base station 4 may be a ground based satellite or radio station 4a. Without loss of generality, a base station 4 may comprise a Point of Presence (PoP) location 4b, wherein the base station 4 and Point of Presence location 4b may be geographically separated or geographically collocated.

The system 1 of the present invention further comprises one or more remote receivers 6 in one-on-one wireless communication 7 with one or more of the one or more base stations 4, wherein the one or more remote receivers 6 are arranged for receiving the transcoded video content therefrom, and for delivering the transcoded video content to one or more playout devices 8. The one or more playout devices 8 are in communication with one of the one or more remote receivers 6. In an embodiment, a playout device 8 may comprise a tablet, mobile phone, laptop or any other computer like device capable of playing the transcoded video content. The one or more playout devices 8 may be viewed as being comprised by the one or more remote receivers 6. For example, in an embodiment a remote receiver 6 may be a mobile remote receiver 6 such as an aircraft or vehicle comprising one or more playout devices 8. In such an embodiment passengers of the aircraft or vehicle would use their playout device 8 for playing the transcoded video content.

It is noted that the bandwidth actually used for the present invention embodiments has its limiting part somewhere in the connection route to the remote receiver 6. When taking video as data to be transmitted, an upper bandwidth limit used is e.g. 2 mbit/s for each channel used. This would allow transmitting video data of e.g. 500 kbps (e.g. SD) or 1 Mbps (e.g. HD) formats. The channels used include e.g. the one-on-one wireless communication 7, which are often bandwidth limited which prevent the use of a higher bit rate. If a higher bandwidth is actually available, it would be possible to transmit more than one video channel to the same remote receiver 6.

An advantageous feature of the system 1 is that the one-on-one wireless communication 7 may be achieved through e.g. a satellite or radio base station 4 without using an intermediate relay station. That is, the one-on-one wireless communication 7 does not rely on an intermediate relay station such as an intermediate satellite or radio station interposed between one or more base stations 4 and one or more remote receivers 6. Therefore, a wireless signal sent by a base station 4 is directly received by a remote receiver 6 without intermediate processing by an intermediate relay station. As a result, the direct, one-on-one wireless communication 7 reduces complexity of the system 1 while increasing responsiveness thereof.

As mentioned above, the content source facility 2 may comprises an encoder unit 2a arranged for encoding video content into the transcoded video content of the predetermined bitrate. In a particular embodiment, for example, the content source facility 2 may comprises an encoder unit 2a arranged for HEVC encoding of video content into the transcoded video content of the predetermined bitrate. In this embodiment HEVC encoding refers to High Efficiency Video Codec, wherein HEVC is a joint venture by the ITU-T Video Coding Experts Group (ITU-T VCEG) and the ISO/IEC Moving Picture Experts Group (ISO/IEC MPEG). This codec is also known as H265 as standardized by the ITU-T VCEG and MPEG-H Part 2 as standardized by the ISO/IEC MPEG. HEVC doubles compression of the widely utilized AVC (H.264 or MPEG-4 Part 10). An advantage of HVEC encoding by the encoder unit 2a is that higher quality of video content can be sent over relatively low bandwidth connections.

In a further embodiment, the encoder unit 2a is arranged for packaging the transcoded video content into an MPEG digital container, e.g. an MPEG transport stream (MPEGTS). In this embodiment the MPEG digital container, e.g. MPEGTS, represents a digital container format for transmission of content and program data (specifically Program and System Information data, also known as PSIP data). The MPEG digital container allows packetizing video content in segments, occasionally repeating system information, so that the one or more playout devices 8 can play the transcoded video content shortly after picking up an MPEG transport stream.

According to the present invention, the system 1 allows for efficient delivery of video content to one or more mobile remote receivers 6, particularly in case of low bandwidth network connections. To further facilitate efficient delivery of video content there is provided an embodiment wherein the one-on-one wireless communication 7 between the one or more remote receivers 6 and the one or more of the one or more base stations 4 comprises one-on-one wireless UDP communication. In this embodiment, one-on-one wireless UDP communication (User Datagram Protocol) allows for a relatively simple transmission protocol that avoids the overhead found in alternative specific transmission techniques such as TCP and TCP spoofing. Furthermore, one-on-one wireless UDP communication significantly reduces reliance on specific transmission techniques.

As mentioned above, the one or more remote receivers 6 are arranged for delivering the transcoded video content to one or more playout devices 8, wherein the one or more playout devices 8 are in communication with one of the one or more remote receivers 6. In case the one or more remote receivers 6 are embodied as aircraft systems (i.e. carried on an aircraft), then an embodiment may be provided wherein (each of) the one or more remote receivers 6 comprises a set top distribution centre 10 in wireless communication 9 with one of the one or more playout devices 8 for delivering the transcoded video content thereto, during flight. In this embodiment the transcoded video content can be efficiently delivered to the one or more playout devices 8 through a set top distribution centre 10 directly receiving the transmitted transcoded video content, e.g. MPEGTS over UDP, by a base station 4 through the one-on-one wireless communication 7. In an advantageous embodiment the set top distribution centre 10 comprises a Wi-Fi router arranged for communicating with the one or more playout devices 8.

In a further aspect the present invention relates to a method of delivering video content to mobile remote receivers 6. Reference is made to FIG. 1, depicting an embodiment of the system 1 as described above, wherein the system 1 is arranged to execute the method. According to the present invention, the method comprises a) providing video content through a content source facility 2 and b) transcoding the video content to a predetermined bitrate at the content source facility 2. The predetermined bitrate is e.g. limited to a maximum value of 2 Mbit/s, which would allow transmitting video data in SD (500 kbps) or HD (1 Mbps) format. The method steps a) and b) are performed as early as possible before any other methods steps are taken for delivering video content to one or more remote receivers 6, so that subsequent methods steps can anticipate and make efficient use of available bandwidth.

The method then continues and comprises c) distributing the transcoded video content from the content source facility 2 to one or more base stations 4. As with the system 1, the one or more base stations 4 may be one or more ground based base stations 4 and in particular ground based satellite or radio stations 4a. The one or more base stations 4 may comprise a Point of Presence (PoP) location 4b, which may or may not be geographically separated from an associated base station 4.

Subsequent parts of the method then involves d) transmitting the transcoded video content from the one or more base stations 4 to one or more remote receivers 6 through one-on-one wireless communication 7, and e) delivering the transcoded video content by the one or more remote receivers 6 to one or more playout devices 8 being in communication with one of the one or more remote receivers 6.

As with the system 1, the one-on-one wireless communication 7 is advantageous, as a base station 4 and a remote receiver 6 are able to communicate without one or more relaying steps, thereby eliminating further reduction of bandwidth and/or introducing further latency, higher roundtrip times, burst errors and so on.

In an embodiment, the one or more remote receivers 6 are mobile remote receivers 6, which are often connected through network connections characterized by low bandwidth, burst errors etc. However, the one-on-one wireless communication 7 of transcoded video content of a predetermined (low) bitrate allows the one or more mobile remote receivers 6 to receive high quality video content despite poor connectivity.

According to the invention, a remote receiver 6, e.g. a mobile remote receiver 6, may comprise one or more playout devices 8 that are in communication with the remote receiver 6. In particular, the remote receiver 6 may be provided with a set top distribution centre 10 which is in communication with the one or more playout devices 8. Therefore, the method step of e) delivering the transcoded video content may comprise delivering the transcoded video content to the one or more playout devices 8 through a set top distribution centre 10 provided to the one of the one or more remote receivers 6. The set top distribution centre 10 may thus provide a central point to a remote receiver 6 from which the transcoded video content can be delivered (“fanned out”) in controllable fashion to the one or more playout devices 8. That is, the set top distribution centre 10 is provided to the one of the one or more remote receivers and receives the transcoded video content, and where it delivers the transcoded video content to the one or more playout devices 8.

In a particular exemplary embodiment the method step of e) delivering the transcoded video content may comprise wirelessly delivering, e.g. through Wi-Fi, the transcoded video content by the set top distribution centre 10 to the one or more playout devices 8, thereby eliminating network wiring at the one of the one or more remote receivers 6.

In a further embodiment, the method step of b) transcoding the video content may comprise transcoding the video content using HVEC encoding. Like the system 1, an advantage of HVEC encoding is that higher quality video content can be sent over relatively low bandwidth connections. HVEC encoding may be combined with utilizing a convenient digital container for e.g. streaming video content. That is, in an embodiment the step of b) transcoding the video content may comprise a subsequent method step of packaging the transcoded video content into a digital container format, e.g. into an MPEG digital container format, e.g. an MPEG transport stream (MPEGTS). The MPEG digital container, such an MPEG transport stream, would allow sending packetizing segments of video content to the one or more playout devices 8, which would then be able to play the transcoded video content shortly after receiving it.

As outlined earlier, an important advantage of the method of the present invention is that video content can be delivered with minimal overhead by transmitting transcoded video content through one-on-one wireless communication 7 between the one or more base stations 4 and the one or more remote receivers 6, thereby allowing for relatively low bandwidth connectivity. In order to further improve delivery of high quality video content over relatively poor network connections, the method step of d) transmitting the transcoded video content may comprise transmitting the transcoded video content using one-on-one wireless UDP communication. In this embodiment, one-on-one wireless UDP communication allows for a simple transmission protocol that avoids overhead found in alternative protocols such as TCP.

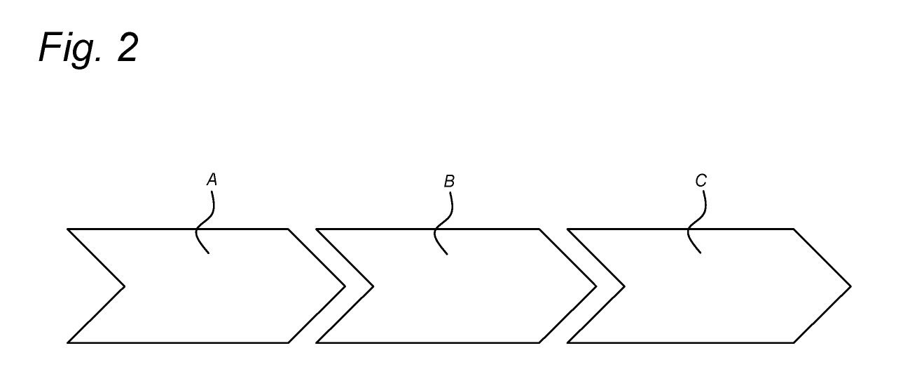

From a general point of view, the system 1 and method for delivering video content to mobile remote receivers according to the present invention can be described by a three layered or three tier distribution model. For example, FIG. 2 shows a schematic view of a three layered distribution model for delivery of video content to mobile remote receivers according to an embodiment of the present invention.

The depicted three layered distribution model comprises a first stage “A” wherein video content is encoded/transcoded to a predetermined bitrate, preferably a sufficiently low bitrate, so that efficient use of bandwidth can be achieved. This first layer of the distribution model is performed as early as possible in the overall delivery process of content, such as at an “edge” point in a network, i.e. where content first enters the network. The content source facility 2 of the system 1 may be considered an edge point of a network as represented by the system 1 shown in FIG. 1.

In this first layer the encoding/transcoding of video content may take place utilizing HVEC as outlined above, and wherein the transcoded video content may be packaged in MPEG, e.g. an MPEG transport stream, and distributed from the content source facility 2 to one or more base stations 4, such as ground based satellite or radio stations 4. From the above it can be inferred that the first layer of the three layered distribution model represents the method methods steps a), b) and c).

The second layer “B” of the three layered distribution model represents the method step d), i.e. transmitting the transcoded video content from the one or more base stations 4 to one or more remote receivers 6 through one-on-one wireless communication 7. This second layer “B” of the distribution model occurs at each of the one or more base stations 4. In this layer the transcoded video content as received from the content source facility 2 is transmitted to each of the one or more remote receivers 6 requesting the transcoded video content. In this second layer it may be advantageous to transmit the transcoded video content over UDP, as the system 1 and method may suffer from being too reliant on networks that only support specific transmission techniques such as TCP/TCP spoofing.

The third layer “C” of the three layered distribution model represents the method step of e), delivering the transcoded video content by the one or more remote receivers 6 to one or more playout devices 8 being in communication with one of the one or more remote receivers 6. In an exemplary embodiment the one or more playout devices 8 may be computer like devices carried by passengers that request the same transcoded video content. The transcoded video content may then be delivered to the one or more playout devices 8 through a wireless set top distribution centre 10.

In summary, contrary to prior art systems using satellite or radio connections for delivering video content to mobile remote receivers, the system 1 and method of the present invention do not rely on multicast and IGMP (Internet Group Management Protocol) to spread content. Instead, transcoded video content “flows” from one distribution stage to a subsequent stage, facilitating management and control of the transcoded video content along each stage. In particular, source video content provided by the content source facility 2 is immediately transcoded to a predetermined bitrate (e.g. low bitrate) and distributed to a base station 4 and transmitted to a mobile remote receiver 6 through one-on-one wireless communication 7. The mobile remote receiver 6 is then able to deliver the transcoded video content to one or more playout devices 8.

As can be seen, the system 1 and method of the present invention provide more control over where video content “flows”, over which routes, and where it is accessible. It allows for manual and automatic prioritization of video content. For example, if there is only sufficient bandwidth for e.g. three channels to a remote receiver 6, a set top distribution centre 10 in one-on-one wireless communication 7 with a base station 4 may negotiate which channels are eventually delivered to the one or more playout devices 8.

The present invention has been described above with reference to a number of exemplary embodiments as shown in the drawings. Modifications and alternative implementations of some parts or elements are possible, and are included in the scope of protection as defined in the appended claims.

1. A method of delivering video content to mobile remote locations, comprising
a) providing video content through a content source facility;
b) transcoding the video content to a predetermined bitrate at the content source facility;
c) distributing the transcoded video content from the content source facility to one or more base stations;
d) transmitting the transcoded video content from the one or more base stations to one or more remote receivers through one-on-one wireless communication; and
e) delivering the transcoded video content by the one or more remote receivers to one or more playout devices being in communication with one of the one or more remote receivers.

2. The method according to claim 1, wherein b) transcoding the video content comprises transcoding the video content using HVEC encoding.

3. The method according to claim 1, wherein b) transcoding the video content comprises a subsequent method step of packaging the transcoded video content into a digital container format.

4. The method according to claim 3, wherein packaging the transcoded video content comprises packaging the transcoded video content into an MPEG digital container format.

5. The method according to claim 1, wherein d) transmitting the transcoded video content comprises transmitting the transcoded video content through one-on-one wireless UDP communication.

6. The method according to claim 1, wherein e) delivering the transcoded video content comprises delivering the transcoded video content to the one or more playout devices through a set top distribution centre provided to the one of the one or more remote receivers.

7. The method according to claim 6, wherein e) delivering the transcoded video content comprises wirelessly delivering the transcoded video content by the set top distribution centre to the one or more playout devices.

8. The method according to claim 1, wherein the one or more base stations are ground based satellite stations or ground based radio stations.

9. The method according to claim 1, wherein one or more of the one or more remote receivers are mobile remote receivers.

10. The method according to claim 9, wherein the mobile remote receivers are aircraft systems.

11. A system for delivering video content to mobile remote locations, comprising
a content source facility arranged for providing transcoded video content of a predetermined bitrate, wherein the content source facility is connected to one or more base stations and arranged to distribute the transcoded video content thereto;
one or more remote receivers in one-on-one wireless communication with one or more of the one or more base stations,
wherein the one or more remote receivers are arranged for receiving the transcoded video content therefrom, and for delivering the transcoded video content to one or more playout devices, wherein the one or more playout devices are in communication with one of the one or more remote receivers.

12. The system according to claim 11, wherein the content source facility comprises an encoder unit arranged for HVEC encoding of video content into the transcoded video content of the predetermined bitrate.

13. The system according to claim 12, wherein the encoder unit is further arranged for packaging the transcoded video content into an MPEG digital container.

14. The system according to claim 11, wherein the one-on-one wireless communication between the one or more remote receivers and the one or more of the one or more base stations comprises one-on-one wireless UDP communication.

15. The system according to claim 11, wherein the one or more remote receivers comprise a set top distribution centre in wireless communication with one of the one or more playout devices for delivering the transcoded video content thereto.
